(19) United States
(12) Patent Application Publication
(10) Pub. No.: US 2015/0019339 A1
(43) Pub. Date: Jan. 15, 2015

(54) DELIVERY OF COMMERCIAL INFORMATION

(71) Applicants: Vinh Van Phan, Oulu (FI); Ling Yu, Oulu (FI); Kari Veikko Horneman, Oulu (FI)

(72) Inventors: Vinh Van Phan, Oulu (FI); Ling Yu, Oulu (FI); Kari Veikko Horneman, Oulu (FI)

(73) Assignee: NOKIA SOLUTIONS AND NETWORKS OY, Espoo (FI)

(21) Appl. No.: 14/388,636

(22) PCT Filed: Mar. 29, 2012
(86) PCT No.: PCT/EP2012/055616

§ 371 Date: Sep. 26, 2014

(51) Int. Cl. G06Q 30/02

(52) U.S. Cl. CPC G06Q 30/0261
USPC 705/14.58

(57) ABSTRACT

The invention relates to an apparatus including at least one processor and at least one memory including a computer program code, the at least one memory and the computer program code configured to, with the at least one processor, cause the apparatus at least to: configure an apparatus capable to device-to-device communications to operate as a local proximity services advertising agent device, and/or configure a proximity services advertising source device to operate as a local proximity services advertising agent device or associate the proximity services advertising source device with an existing local proximity services advertising agent device, and provide commercial information to the local proximity services advertising agent device for local delivery.

### FIELD

The invention relates to apparatuses, methods, systems, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

In today's world people are used to communicate wherever they are. They want to surf the net when the mood takes them, for example. Thus, service provides are interested in responding to this challenge and develop services to suit their customers' needs. Some potential services suitable for this mobile lifestyle referred to as Proximity Services (ProSe), are under development. One potential ProSe use case is local advertising.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: configure an apparatus capable to device-to-device communications to operate as a local proximity services advertising agent device, and/or configure a proximity services advertising source device to operate as a local proximity services advertising agent device or associate the proximity services advertising source device with an existing local proximity services advertising agent device, and provide commercial information to the local proximity services advertising agent device for local delivery.

According to an aspect of the present invention, there is provided an apparatus comprising: at least one processor and at least one memory including a computer program code, the at least one memory and the computer program code configured to, with the at least one processor, cause the apparatus at least to: carry out configuration to operate as a local proximity services advertising agent device, the configuration comprising arranging device-to-device communication with a serving network, at least one proximity services advertising source device, and/or at least one first local proximity services advertising agent device, obtain commercial information for local delivery from the serving network, from the at least one proximity services advertising source device, and/or the at least one first local proximity services advertising agent device and deliver the commercial information to at least one receiving device and/or to at least one second local proximity services advertising agent device.

According to an aspect of the present invention, there is provided an apparatus comprising: at least one processor and at least one memory including a computer program code, the at least one memory and the computer program code configured to, with the at least one processor, cause the apparatus at least to: obtain information to operate as a local proximity services advertising agent device from a serving network, if no suitable proximity services advertising agent devices are detected, inform the serving network on suitable proximity services advertising agent devices and obtain information for being associated to at least one of the suitable proximity services advertising agent devices, if at least one suitable proximity services advertising agent device is detected, and deliver commercial information to at least one receiving device and/or to the at least one of the suitable proximity services advertising agent devices.

According to an aspect of the present invention, there is provided an apparatus comprising: at least one processor and at least one memory including a computer program code, the at least one memory and the computer program code configured to, with the at least one processor, cause the apparatus at least to: obtain commercial information from a proximity services advertising source device via a local proximity services advertising agent device, and request a connection to the proximity services advertising source device via the local proximity services advertising agent device, the connection being in relation to a commercial information forwarding indicator and/or to the obtained commercial information, or request a connection to a network indicating the connection being in relation to a commercial information forwarding indicator and/or the obtained commercial information.

According to yet another aspect of the present invention, there is provided a method comprising: configuring an apparatus capable to device-to-device communications to operate as a local proximity services advertising agent device, and/or configuring a proximity services advertising source device to operate as a local proximity services advertising agent device or associate the proximity services advertising source device with an existing local proximity services advertising agent device, and providing commercial information to the local proximity services advertising agent device for local delivery.

According to yet another aspect of the present invention, there is provided a method comprising: carrying out configuration to operate as a local proximity services advertising agent device, the configuration comprising arranging device-to-device communication with a serving network, at least one proximity services advertising source device, and/or at least one first local proximity services advertising agent device, obtaining commercial information for local delivery from the serving network, from the at least one proximity services advertising source device, and/or the at least one first local proximity services advertising agent device and delivering the commercial information to at least one receiving device and/or to at least one second local proximity services advertising agent device.

According to yet another aspect of the present invention, there is provided a method comprising: obtaining information to operate as a local proximity services advertising agent device from a serving network, if no suitable proximity services advertising agent devices are detected, inform the serving network on suitable proximity services advertising agent devices and obtaining information for being associated to at least one of the suitable proximity services advertising agent devices, if at least one suitable proximity services advertising agent device is detected, and delivering commercial information to at least one receiving device and/or to the at least one of the suitable proximity services advertising agent devices.

According to yet another aspect of the present invention, there is provided a method comprising: obtaining commercial information from a proximity services advertising source device via a local proximity services advertising agent device, and requesting a connection to the proximity services advertising source device via the local proximity services advertising agent device, the connection being in relation to a commercial information forwarding indicator and/or to the obtained commercial information, or requesting a connection to a network indicating the connection being in relation to a commercial information forwarding indicator and/or the obtained commercial information.

According to yet another aspect of the present invention, there is provided an apparatus comprising: means for configuring an apparatus capable to device-to-device communications to operate as a local proximity services advertising agent device, and/or means for configuring a proximity services advertising source device to operate as a local proximity services advertising agent device or associate the proximity services advertising source device with an existing local proximity services advertising agent device, and means for providing commercial information to the local proximity services advertising agent device for local delivery.

According to yet another aspect of the present invention, there is provided an apparatus comprising: means for carrying out configuration to operate as a local proximity services advertising agent device, the configuration comprising arranging device-to-device communication with a serving network, at least one proximity services advertising source device, and/or at least one first local proximity services advertising agent device, means for obtaining commercial information for local delivery from the serving network, from the at least one proximity services advertising source device, and/or the at least one first local proximity services advertising agent device and means for delivering the commercial information to at least one receiving device and/or to at least one second local proximity services advertising agent device.

According to yet another aspect of the present invention, there is provided an apparatus comprising: means for obtaining information to operate as a local proximity services advertising agent device from a serving network, if no suitable proximity services advertising agent devices are detected, inform the serving network on suitable proximity services advertising agent devices and means for obtaining information for being associated to at least one of the suitable proximity services advertising agent devices, if at least one suitable proximity services advertising agent device is detected, and means for delivering commercial information to at least one receiving device and/or to the at least one of the suitable proximity services advertising agent devices.

According to yet another aspect of the present invention, there is provided an apparatus comprising: means for obtaining commercial information from a proximity services advertising source device via a local proximity services advertising agent device, and means for requesting a connection to the proximity services advertising source device via the local proximity services advertising agent device, the connection being in relation to a commercial information forwarding indicator and/or to the obtained commercial information or requesting a connection to a network indicating the connection being in relation to a commercial information forwarding indicator and/or the obtained commercial information.

According to yet another aspect of the present invention, there is provided a computer program embodied on a computer-readable storage medium, the computer program comprising program code for controlling a process to execute a process, the process comprising: configuring an apparatus capable to device-to-device communications to operate as a local proximity services advertising agent device, and/or configuring a proximity services advertising source device to operate as a local proximity services advertising agent device or associate the proximity services advertising source device with an existing local proximity services advertising agent device, and providing commercial information to the local proximity services advertising agent device for local delivery.

According to yet another aspect of the present invention, there is provided a computer program embodied on a computer-readable storage medium, the computer program comprising program code for controlling a process to execute a process, the process comprising: carrying out configuration to operate as a local proximity services advertising agent device, the configuration comprising arranging device-to-device communication with a serving network, at least one proximity services advertising source device, and/or at least one first local proximity services advertising agent device, obtaining commercial information for local delivery from the serving network, from the at least one proximity services advertising source device, and/or the at least one first local proximity services advertising agent device and delivering the commercial information to at least one receiving device and/or to at least one second local proximity services advertising agent device.

According to yet another aspect of the present invention, there is provided a computer program embodied on a computer-readable storage medium, the computer program comprising program code for controlling a process to execute a process, the process comprising: obtaining information to operate as a local proximity services advertising agent device from a serving network, if no suitable proximity services advertising agent devices are detected, inform the serving network on suitable proximity services advertising agent devices and obtaining information for being associated to at least one of the suitable proximity services advertising agent devices, if at least one suitable proximity services advertising agent device is detected, and delivering commercial information to at least one receiving device and/or to the at least one of the suitable proximity services advertising agent devices.

According to yet another aspect of the present invention, there is provided a computer program embodied on a computer-readable storage medium, the computer program comprising program code for controlling a process to execute a process, the process comprising: obtaining commercial information from a proximity services advertising source device via a local proximity services advertising agent device, and requesting a connection to the proximity services advertising source device via the local proximity services advertising agent device, the connection being in relation to a commercial information forwarding indicator and/or to the obtained commercial information, or requesting a connection to a network indicating the connection being in relation to a commercial information forwarding indicator and/or the obtained commercial information.

### LIST OF DRAWINGS

Some embodiments of the present invention are described below, by way of example only, with reference to the accompanying drawings, in which

FIGS. 1A and 1B illustrate examples of systems;

FIG. 2 is a flow chart;

FIG. 3 is another flow chart;

FIG. 4 is yet another flow chart;

FIG. 5 is yet another flow chart;

FIG. 6 illustrates examples of apparatuses;

FIG. 7 illustrates other examples of apparatuses;

FIG. 8 illustrates yet other examples of apparatuses, and

FIG. 9 illustrates yet other examples of apparatuses.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, as well as to any network element, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS).

In an orthogonal frequency division multiplexing (OFDM) system, the available spectrum is divided into multiple orthogonal sub-carriers. In OFDM systems, the available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule transmissions to user devices. Such required information is usually signalled to the (e)NodeB.

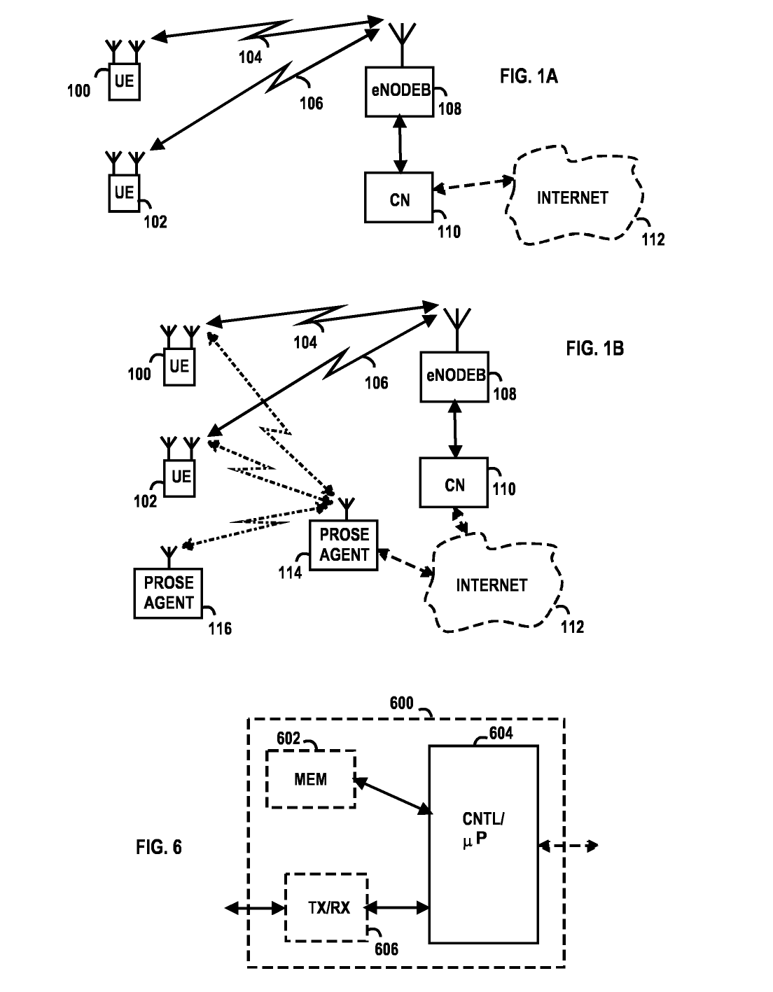

FIG. 1A depicts examples of simplified system architectures only showing some elements and functional entities, all being logical units, whose implementation may differ from what is shown. The connections shown in FIG. 1A are logical connections; the actual physical connections may be different. It is apparent to a person skilled in the art that the system typically comprises also other functions and structures than those shown in FIG. 1A.

The embodiments are not, however, restricted to the system given as an example but a person skilled in the art may apply the solution to other communication systems provided with necessary properties.

FIG. 1A shows a part of a radio access network based on E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1A shows user devices 100 and 102 configured to be in a wireless connection on one or more communication channels 104 and 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to as a base station, an access point or any other type of interfacing device including a relay station capable of operating in a wireless environment.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1A, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1A) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeBs of FIG. 1A may provide any kind of these cells. A cellular radio system may be implemented as a multilayer network including several kinds of cells. Typically, in multilayer networks, one node B provides one kind of a cell or cells, and thus a plurality of (e) Node Bs are required to provide such a network structure.

Recently for fulfilling the need for improving the deployment and performance of communication systems, the concept of “plug-and-play” (e)Node Bs has been introduced. Typically, a network which is able to use “plug-and-play” (e)Node (e)Bs, includes, in addition to Home (e)Node Bs (H(e)nodeBs), a home node B gateway, or HNB-GW (not shown in FIG. 1A). A HNB Gateway (HNB-GW), which is typically installed within an operator's network may aggregate traffic from a large number of HNBs back to a core network.

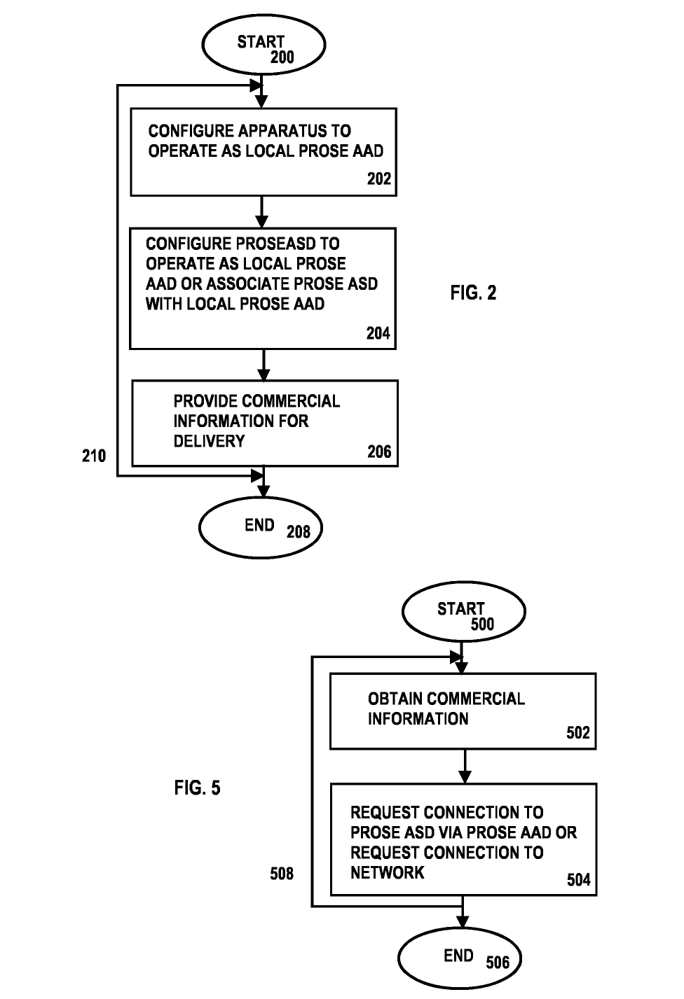

In the following, some embodiments are disclosed in further details in relation to FIGS. 2, 3, 4 and 5. Some embodiments are especially suitable for providing proximity services. Device-to-device (D2D, or machine-to-machine (M2M)) communications is expected to become one of the key features in future communications networks. It is designed to provide an option to offload (cellular) communications system, reduce battery consumption and increase bit-rate, and hence also enable new services. Device to device (D2D) communications may be implemented as an underlay to an LTE-Advanced network. The network may establish a new type of radio bearer dedicated for D2D communications and stay in control of session setup and radio resources without routing user plane traffic. D2D is considered to be used mainly in shot range applications, such as providing local services.

In network-controlled D2D communications, user devices may have both cellular (at least some default signalling bearers for network control purposes) and D2D bearers configured, thus they may have a “mixed” configuration. The user devices may be configured to switch between communicating with a serving (e)NB in a regular cellular access mode (on a cellular radio bearer) and with each other in a D2D mode (on a D2D radio bearer) in a time-division or time-sharing fashion. Thus, D2D communication may be carried out while the user devices are in a discontinuous reception (DRX) mode of the serving cell. A discontinuous reception mode is provided to improve the battery life of a user device and is thus quite typically used in the LTE (-A) networks to provide a better user experience.

In the “mixed” configuration case described above, a network may utilize clusters in order to reduce signalling: an (e) node B may allocate resources for a cluster and the cluster head or a master device further allocates them to cluster members. It should be understood that acting as a cluster head may require node-like operation from a user device. Clusters may also be flexible and thus alter according to needs and/or time. User devices may enter and leave a cluster when they move from one coverage area to another, for example.

Network-controlled D2D communications is suitable for conveying commercial information, such as advertisements or information on products or services ordered by a customer. Some potential services are referred to as Proximity Services (ProSe). One of these potential ProSe use cases is local advertising.

In an exemplifying practical case, for providing D2D based local hyper-advertising services of ProSe-type, a serving (LTE-A) network typically needs to support hundreds of local advertising sources (devices of local restaurants, shops, play stations, e-service machines, etc.) desired to be discovered by thousands of potential receiving ends (devices of customers walking or hanging around) and possibilities for the receiving ends to choose what advertisements they receive and when, and to interact or communicate with selected sources of interest.

Some embodiments suitable for this kind of advertising and for delivering commercial information in general are explained below. A proximity service (ProSe) advertising agent device (ProSe AAD) is introduced to serve typically a group of local proximity service advertising source devices (ProSe ASD(s)) which wish to deliver commercial information locally. A ProSe AAD may cooperate with a ProSe ASD to transmit or broadcast an advertisement over a certain service area and it may be configured and controlled by a network. A ProSe ASD may be configured to deliver advertisements by a request of an end user or customer, or automatically, for instance in a certain area for a certain period of time.

Additionally, a ProSe advertisement receiving device (ProSe ARD) is introduced to provide an end-user an option to listen to or receive advertisements by their own initiative. A ProSe ARD may receive an advertisement when located in a certain service area and this deliver operation may be allowed and/or assisted by a network.

The proximity service advertising agent device concept is designed to provide improved scalability and/or efficiency of proximity service local hyper advertising services. The names of devices, units, modules etc., such as ProSe AAD or ProSe ASD, are not limiting but chosen to be descriptive and separable enough to be used in explaining their roles and/or functionality.

Advertising may herein mean all kinds of commercial information, such as advertisements of products or services, additional information of a product or service of interest requested by a possible customer, contact information, information on business hours, preview material (such as videoclips of films), recommendations of products or services, banners, etc.

A proximity service advertising agent device may be selected among local proximity service advertising source devices dynamically. Proximity service advertising source devices may be associated and thus enabled to communicate with selected ProSe AAD(s).

One embodiment may be carried out by a device configured to operate as a network apparatus, such as a server, (e)node or host. The embodiment starts in block 200 of FIG. 2.

In block 202, an apparatus capable to device-to-device communications is configured to operate as a local proximity services advertising agent device, and/or a proximity services advertising source device is configured to operate as a local proximity services advertising agent device, or it is associated with an existing local proximity services advertising agent device (block 204).

In an embodiment, a local D2D device may be dynamically selected or semi-statically deployed and reconfigured to operate as a ProSe advertising agent device (ProSe AAD) for one or more local ProSe advertising source devices (ProSe ASD) which may be located within the D2D range of ProSe AAD. The local D2D device may be a “general-purpose” mobile device or a specific device or machine configured and controlled by a serving network. On the other hand, a device wishing to deliver commercial information may be chosen to operate as a ProSe advertising agent device (ProSe AAD) for its own needs and even for other ProSe advertising source devices (ProSe ASD). It may be a “general-purpose” mobile device or a specific device or machine configured and controlled by a serving network as well. For instance, a ProSe AAD may be selected among local co-located ProSe ASDs and reconfigured dynamically on-the-fly in a self-organizing networks (SON) based fashion or deployed semi-statically in a pre-configuring fashion by the serving network. The next generation mobile networks (NGMN) alliance and 3rd generation partnership project (3GPP) have standardized a set of capabilities known as self-organizing networks (SON). SON is targeted to simplify operation and maintenance of networks and thus decrease operational expenses (OPEX) by reducing pre-planning of network configurations. SON provides self-configuring of networks for “plug-and-play” devices and also some self-operating and self-optimisation features, such as multivendor tracing, quality-of-services optimisation and interference control.

A device operating as a ProSe AAD may be kept in a radio resource control (RRC) connected state with regard to a serving (cellular) network for control and management purposes. Hence, a ProSe AAD may be configured to convey common control signalling concerning advertising-agent identity, capability and capacity including imposed access limitations and restrictions over designated radio channel(s). A ProSe AAD may also be configured to interact with the serving network for updates or changes in statuses, conditions, users including associated ProSe ASDs, etc.

A serving network may determine whether to select and configure a ProSe ASD to operate as a ProSe AAD or to associate it with one or more existing co-located ProSe AADs based on measurement reports and service requests from the ProSe ASD in question. Thus, a ProSe ASD may, upon an initial access or an updated request for a ProSe service or in response to a request from the serving network, report about detected suitable ProSe AADs. The report may include information on their identities, profile characteristics, capabilities, locations, etc.

The ProSe ASD may also indicate its own profile and capability information, advertising need, location information, and/or status information including available power and network connectivity options or conditions (such as whether ProSe ASD has sufficient power supply or an alternative network connection via other than cellular access, such as fixed line with a valid Internet Protocol (IP) address).

It should be appreciated that a serving network may also provide assistance for a ProSe ASD in the detection of suitable ProSe AADs, such as mapping location information and service request of the ProSe ASD to perform updated location awareness information stored in the serving network.

A serving network may choose as a suitable ProSe AAD a ProSe ASD that is in an isolated position and has not detected a suitable ProSe AADs or has only a few ProSe AADs around which are in less advantageous directions for radio communications or has not sufficient capability. Some other criteria may be at least one of the following: available capacity, power supply, and a possible alternative network connection (such as IP) of ProSe ASDs in question, and special advertising needs or targeted users, etc.

When a serving network is associating a ProSe ASD to a selected ProSe AAD, the serving network may configure and control both the ProSe ASD(s) and the selected ProSe AAD for possible D2D communications between these devices. In this case, the ProSe AAD may operate as a master device (or a cluster head when a group of ProSe ASDs are involved) for the ProSe ASD(s). When D2D communications is successfully established between the ProSe ASD(s) and the ProSe AAD, the serving network may command the ProSe ASD(s) in a sleep mode (DRX) in a radio resource control connected state or in an idle state in the serving network's point of view, while maintaining a D2D connection with the ProSe AAD for needed services. The ProSe AAD may operate as an “access point” for ProSe agent services of interest for ProSe ASD(s). If the D2D communication fails, the serving network may provide mediating services between the ProSe ASD and the ProSe AAD.

The serving network may command a ProSe AAD to carry out a transmission power ramp-up or down upon each addition, modification or removal of an associated ProSe ASD or a requested ProSe service, using derivation rules, up/down power adjustment steps and/or maximum/minimum allowed power levels, etc.

It should be appreciated that a (cellular) network may receive a service request from a ProSe ASD which may include information on priority and/or commercial information factor identifying the piece of information in question. The network may convey the information to selected ProSe AADs.

In block 206, provide commercial information to the local proximity services advertising agent device for local delivery.

Commercial information is typically made previously and stored in a memory unit controlled by a server. The memory unit may be controlled by the network server or by a separate service provider's server. An example of such a service provider is a web advertising company or a radio/TV broadcasting company. The service provider may also be a local company, such as a restaurant, which wishes to provide its' commercial information independently or by using an appropriate advertising or corresponding service. Home nodes may be used for this purpose as well. Cloud services may also be utilized.

The network server may transmit the commercial information in question to the local proximity services advertising agent device serving a desired geographical area, such as a town, part of a town or city, shopping center, or particular street etc.

The embodiment ends in block 208. The embodiment is repeatable in many ways. One example is shown by arrow 210 in FIG. 2.

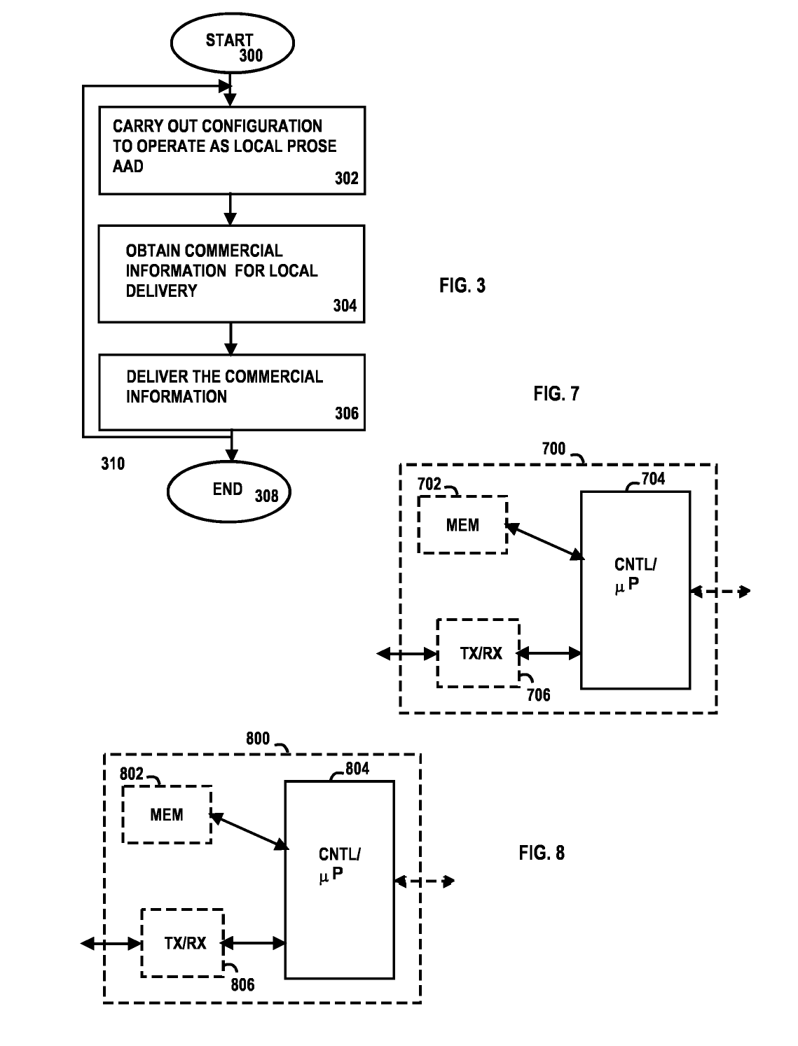

Another embodiment which may be carried out by a node, host, server, user device or relay node suitable for operating as a ProSe AAD will now be explained by means of FIG. 3. The embodiment starts in block 300.

In block 302, configuration to operate as a local proximity services advertising agent device is carried out. The configuration comprises arranging device-to-device communication with a serving network, at least one proximity services advertising source device, and/or at least one first local proximity services advertising agent device.

The configuration may be launched by a serving network.

In an embodiment, a local D2D device may be dynamically selected or semi-statically deployed and reconfigured to operate as a ProSe advertising agent device (ProSe AAD) for one or more local ProSe advertising source devices (ProSe ASD) which may be located within the D2D range of ProSe AAD. The local D2D device may be a “general-purpose” mobile device or a specific device or machine configured and controlled by a serving network. It may not be a source device of commercial information. On the other hand, a device wishing to deliver commercial information may be chosen to operate as a ProSe advertising agent device (ProSe AAD) for its own needs and even for other ProSe advertising source devices (ProSe ASD(s)). It may be a “general-purpose” mobile device or a specific device or machine configured and controlled by a serving network as well. A serving network may choose as a suitable ProSe AAD a ProSe ASD that is in an isolated position and has not detected a suitable ProSe AADs or has only a few ProSe AADS around which are in less advantageous directions for radio communications or has not sufficient capability. Some other criteria may be at least one of the following: available capacity, power supply, and a possible alternative network connection (such as IP) of ProSe ASDs in question, and special advertising needs or targeted users, etc.

A serving network may command a ProSe AAD in a radio resource connection connected state with regard to a serving network for control and management purposes. Hence, a ProSe AAD may configure itself to convey common control signalling concerning advertising-agent identity, capability and capacity including imposed access limitations and/or restrictions over designated radio channel(s). A ProSe AAD may also configure itself to interact with the serving network for updates or changes in statuses, conditions, users including associated ProSe ASDs, etc.

A serving network may configure and control a ProSe AAD for possible D2D communications between the ProSe AAD and ProSe ASD devices. In this case, the ProSe AAD may operate as a master device (or a cluster head when a group of ProSe ASDs are involved) for the ProSe ASD(s). When D2D communications is successfully established between the ProSe ASD(s) and the ProSe AAD, a D2D connection with the ProSe AAD may be used by the ProSe ASD(s) to access the serving network for needed services. The ProSe AAD may operate as an “access point” for the ProSe agent services of interest for ProSe ASD(s).

The serving network may command a ProSe AAD to carry out a transmission power ramp-up or down upon each addition, modification or removal of an associated ProSe ASD or a requested ProSe service, using derivation rules, up/down power adjustment steps and/or maximum/minimum allowed power levels, etc.

In block 304, commercial information for local delivery is obtained from the serving network, from the at least one proximity services advertising source device, and/or the at least one first local proximity services advertising agent device.

Commercial information is typically made previously and stored in a memory unit controlled by a server. The memory unit may be controlled by the network server or by a separate service provider's server. An example of such a service provider is a web advertising company or a radio/TV broadcasting company. The service provider may also be a local company, such as a restaurant, which wishes to provide its' commercial information independently or by using an appropriate advertising or corresponding service. Home nodes may be used for this purpose as well. Cloud services may also be utilized.

A local delivery may be a delivery in a selected geographical area, such as a town, part of a town or city, shopping center, or particular street etc. When a local delivery is provided, an option to focus commercial information with regard to a selected area exists.

In block 306, the commercial information is delivered to at least one receiving device and/or to at least one second local proximity services advertising agent device.

The delivery may be carried out by transmitting or broadcasting commercial information via a wireless connection to receiving devices in the area served by the ProSe AAD in question. A fixed line may also be used. The receiving devices are typically devices of customers listening to radio, watching TV or browsing network. The customers may also be passive, that is they have their devices open but they are not actively using them at the moment of the information delivery.

The embodiment ends in block 308. The embodiment is repeatable in many ways. One example is shown by arrow 310 in FIG. 3.

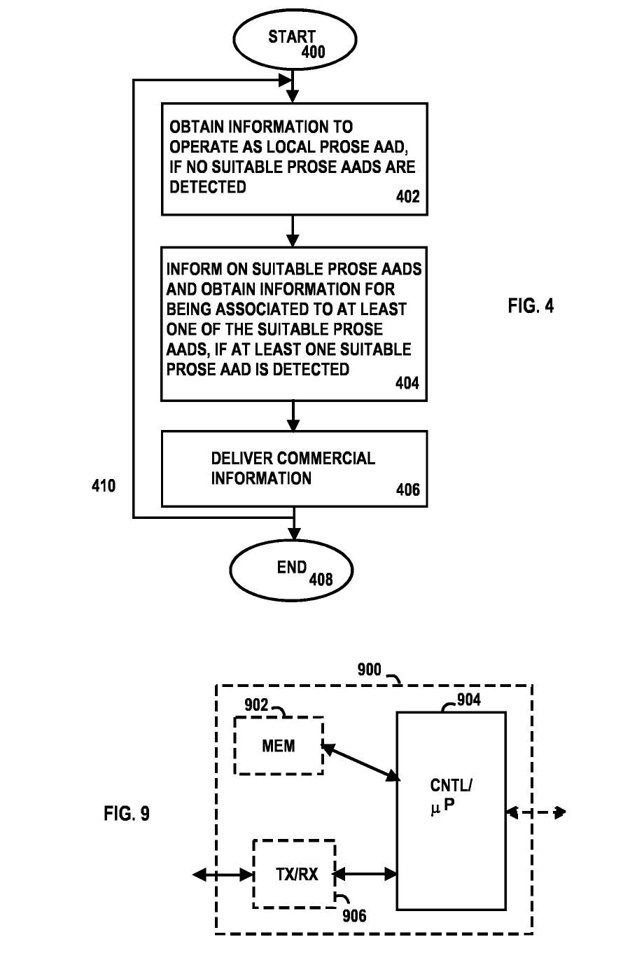

Another embodiment which may be carried out by a node, host, server, user device or relay node suitable to operate as a ProSe ASD will now be explained by means of FIG. 4. The embodiment starts in block 400.

In block 402, if no suitable proximity services advertising agent devices are detected, information to operate as a local proximity services advertising agent device is obtained from a serving network.

A ProSe ASD may detect available ProSe AADs periodically and obtained results are stored for later use or the detection is carried out in relation to need to convey commercial information. In the detection, the device may listen to ProSe AADs to find out which ones it can hear and it may even transmit some kind of an access message.

It should be appreciated that a serving network may also provide assistance for a ProSe ASD in the detection of suitable ProSe AADs, such as mapping location information and service request of the ProSe ASD to perform updated location awareness information stored in the serving network.

A ProSe ASD may indicate to a serving network its own profile and capability information, advertising need, location information, and/or status information including available power and network connectivity options or conditions (such as whether the ProSe ASD has sufficient power supply or an alternative network connection via other than cellular access, such as fixed line with a valid Internet Protocol (IP) address).

In an embodiment, a local D2D device may be dynamically selected or semi-statically deployed and reconfigured to operate as a ProSe advertising agent device (ProSe AAD) for one or more local ProSe advertising source devices (ProSe ASD) which may be located within the D2D range of ProSe AAD. The local D2D device may be a “general-purpose” mobile device or a specific device or machine configured and controlled by a serving network. It may not be a source device of commercial information. On the other hand, a device wishing to deliver commercial information may be chosen to operate as a ProSe advertising agent device (ProSe AAD) for its own needs and even for other ProSe advertising source devices (ProSe ASD). It may be a “general-purpose” mobile device or a specific device or machine configured and controlled by a serving network as well. For instance, a ProSe AAD may be selected among local co-located ProSe ASDs and reconfigured dynamically on-the-fly in a self-organizing networks (SON) based fashion or deployed semi-statically in a pre-configuring fashion by the serving network.

A serving network may choose as a suitable ProSe AAD a ProSe ASD that is in an isolated position and has not detected a suitable ProSe AADs or has only a few ProSe AADS around which are in less advantageous directions for radio communications or has not sufficient capability. Some other criteria may be at least one of the following: available capacity, power supply, and a possible alternative network connection (such as IP) of ProSe ASDs in question, and special advertising needs or targeted users, etc.

In block 404, if at least one suitable proximity services advertising agent device is detected, the serving network is informed on suitable proximity services advertising agent devices and obtain information for being associated to at least one of the suitable proximity services advertising agent devices.

A ProSe ASD may, upon an initial access or an updated request for a ProSe service or in response to a request from the serving network, report about detected suitable ProSe AADs. The report may include information on their identities, profile characteristics, capabilities, location and/or possible commercial information factors (flooding factors or flags) (see the example below). A flooding factor may be used by a ProSe ASD to request for commercial information, such as one or more advertisements.

A serving network may determine whether to select and configure a ProSe ASD to operate as a ProSe AAD or to associate it with one or more existing co-located ProSe AADs based on measurement reports and service requests from the ProSe ASD in question.

When a serving network is associating a ProSe ASD to a selected ProSe AAD, the serving network may configure and control both the ProSe ASD(s) and the selected ProSe AAD for possible D2D communications between these devices. In this case, the ProSe AAD may operate as a master device (or a cluster head when a group of ProSe ASDs are involved) for the ProSe ASD(s). When D2D communications is successfully established between the ProSe ASD(s) and the ProSe AAD, the serving network may command the ProSe ASD(s) in a sleep mode (DRX) in a radio resource connected state or in an idle state in the serving network's point of view, while maintaining a D2D connection with the ProSe AAD for needed services. The ProSe AAD may operate as an “access point” for the ProSe agent services of interest for ProSe ASD(s). If the D2D communication fails, the serving network may provide mediating services between the ProSe ASD and the ProSe AAD.

In block 406 commercial information is delivered to at least one receiving device and/or to the at least one of the suitable proximity services advertising agent devices.

Commercial information is typically made previously and stored in a memory unit controlled by a server. The memory unit may be controlled by the network server or by a separate service provider's server. An example of such a service provider is a web advertising company or a radio/TV broadcasting company. The service provider may also be a local company, such as a restaurant, which wishes to provide its' commercial information independently or by using an appropriate advertising or corresponding service. Home nodes may be used for this purpose as well. Cloud services may also be utilized.

ProSe ASD as a source device, may communicate with the server storing commercial information or it may store it itself. If the commercial information is stored outside the source device, it may request the commercial information from the server controlling the storage. The delivering the commercial information may be launched by a request from a receiving device, such as a request for additional information on a service or product of interest, or it may be launched by the source device, such as broadcasting an advertisement in a selected area in selected time.

By using a local ProSe AAD, a local delivery may be provided. Local delivery may be a delivery in a selected geographical area, such as a town, part of a town or city, shopping center, or particular street etc. When a local delivery is provided, an option to focus commercial information with regard to a selected area exists.

The delivery may be carried out by transmitting or broadcasting commercial information via a wireless connection to receiving devices in the area served by the ProSe AAD in question. A fixed line may also be used. The receiving devices are typically devices of customers listening to radio, watching TV or browsing network. The customers may also be passive, that is they have their devices open but they are not actively using them at the moment of the information delivery.

The embodiment ends in block 408. The embodiment is repeatable in many ways. One example is shown by arrow 410 in FIG. 4.

Yet another embodiment which may be carried out by a user device or corresponding device, suitable for operating as a ProSe advertisement receiving device (ProSe ARD) will now be explained by means of FIG. 5. The embodiment starts in block 500.

In block 502, commercial information is obtained from a proximity services advertising source device via a local proximity services advertising agent device.

The commercial information may be obtained as a transmission or broadcast from a ProSe AAD.

In block 504, a connection to the proximity services advertising source device via the local proximity services advertising agent device is requested, the connection being in relation to a commercial information forwarding indicator and/or to the obtained commercial information, or a connection to a network is requested indicating the connection being in relation to a commercial information forwarding indicator and/or the obtained commercial information.

A proximity services advertising receiving device (ProSe ARD) may initiate a local D2D call or other suitable typically radio connection to the ProSe ASD via the local ProSe AAD from which the ProSe ARD receives the commercial information. A commercial information forwarding indicator, such as a flooding factor or flag, may relate to obtained commercial information of the ProSe ASD in question (or to one or more possible intermediate ProSe AADS). Otherwise a connection request to a (cellular) network may be initiated indicating that the connection is in relation to the obtained commercial information. Thus an end user or client may indicate his or her interest to obtain more detailed or related information. The connection may provide a connection to a web page providing the more detailed information or more detailed commercial information may be transmitted, etc.

The embodiment ends in block 506. The embodiment is repeatable in many ways. One example is shown by arrow 508 in FIG. 5.

In the following, an example of a case wherein more than one ProSe AADs are used is explained in further detail. The example is presented herein only for clarification purposes and it should not be taken as limiting implementation of embodiments. An exemplary system with two ProSe AADs is shown in FIG. 1B. In FIG. 1B which is based on the exemplary system shown in FIG. 1A, same reference numbers refer to same units, elements or connections than those of FIG. 1A.

This exemplary system comprises two proximity services advertising agents 114, 116. ProSe AAD 114 operates as a “first tier” device which may further communicate with another “second tier” ProSe AAD 116. The “first tier” ProSe AADs is an “original” ProSe AAD and the “second tier” ProSe AAD is an intermediate ProSe AADs as will be further clarified in the following:

In an embodiment, a ProSe ASD may request commercial information having a specified priority and one or more commercial information factors, also called flooding factors which determine desirable scheduling allocation and extending range of the commercial information. For instance, a flooding factor may be used to request whether (a particular piece of) ProSe commercial information should be kept in a selected geographical area that is to say, kept within the D2D range of the requesting ProSe ASD, and thus broadcasted by a direct neighbouring ProSe AAD(s) (also referred to as 1st tier), or forwarded to and broadcasted by one or more intermediate ProSe AAD which are located outside the D2D range of the requesting ProSe ASD (also referred to 2nd and farther tier(s)). In this regard, a ProSe AAD upon conveying commercial information (or advertising) of a ProSe ASD to a next ProSe AAD or end users may also indicate one or more commercial information factors (flooding factors or flags) e.g. by using, indicating flags, associated with the commercial information. In one more specific example, the flag is set to 1 when the direct or original ProSe AAD receives a service request directly from the original ProSe ASD and then incrementally increased by 1 each time a ProSe AAD passes it further to the next one over a possible D2D connection (until the maximum value is reached).

The serving network may provide assistance in conveying requested commercial information to selected ProSe AADs over the service area of interest and/or configure the flooding factor or flag to selected ProSe AADs, especially when a D2D connection between ProSe AADs is not in use, out of order, or established.

A ProSe advertisement receiving device(s) (ProSe ARD), upon initiating a call request to reach a ProSe ASD, may indicate to a serving network the flooding factor or flag corresponding to the received information. Based on that, the serving network may determine whether to establish regular cellular access connections to the ProSe ARD and the ProSe ASD to conduct communications, or to use D2D communications.

Additionally, a ProSe ARD may, upon receiving commercial information from a direct ProSe AAD (tier 1) and wishing to contact the original ProSe ASD for further information or transaction, may try initiating communications directly with the ProSe AAD it is currently listening to over an existing D2D connection. The ProSe AAD in question is also configured to support direct communications of this type.

It is appreciated that a ProSe ASD and/or a ProSe AAD may have an alternative connection to a serving network via a fixed or wireless IP access over digital subscriber line (DSL) or Institute of electrical and electronics engineers (IEEE) WiFi, for example. This connection may be utilized for control, management and networking purposes to deal with possible radio interference between local cellular and D2D communications.

The steps/points, signaling messages and related functions described above in FIGS. 2, 3, 4 and 5 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, broadcasting, transmitting and/or receiving may herein mean preparing a data conveyance, broadcast, transmission and/or reception, preparing a message to be conveyed, broadcasted, transmitted and/or received, or physical transmission and/or reception itself, etc. on a case by case basis. The same principle may be applied to terms transmission and reception as well.

An embodiment provides an apparatus which may be any user device or relay node suitable for operating as a master device of a device cluster or any other suitable apparatus capable to carry out processes described above in relation to FIG. 2.

FIG. 6 illustrates a simplified block diagram of an apparatus according to an embodiment.

As an example of an apparatus according to an embodiment, it is shown apparatus 600, such as user device or web stick, including facilities in control unit 604 (including one or more processors, for example) to carry out functions of embodiments according to FIG. 2. The facilities may be software, hardware or combinations thereof as described in further detail below.

In FIG. 6, block 606 includes parts/units/modules needed for reception and transmission, usually called a radio front end, RF-parts, radio parts, radio head, etc.

Another example of apparatus 600 may include at least one processor 604 and at least one memory 602 including a computer program code, the at least one memory and the computer program code configured to, with the at least one processor, cause the apparatus at least to: configure an apparatus capable to device-to-device communications to operate as a local proximity services advertising agent device, and/or configure a proximity services advertising source device to operate as a local proximity services advertising agent device or associate the proximity services advertising source device with an existing local proximity services advertising agent device, and provide commercial information to the local proximity services advertising agent device for local delivery.

Yet another example of an apparatus comprises means 604 (606) for configuring an apparatus capable to device-to-device communications to operate as a local proximity services advertising agent device, and/or means 604 (606) for configuring a proximity services advertising source device to operate as a local proximity services advertising agent device or associate the proximity services advertising source device with an existing local proximity services advertising agent device, and means 604 (606) for providing commercial information to the local proximity services advertising agent device for local delivery.

Yet another example of an apparatus comprises a first operation unit configured to configure an apparatus capable to device-to-device communications to operate as a local proximity services advertising agent device, and/or a second operation unit configured to configure a proximity services advertising source device to operate as a local proximity services advertising agent device or associate the proximity services advertising source device with an existing local proximity services advertising agent device, and a provider configured to provide commercial information to the local proximity services advertising agent device for local delivery.

It should be understood that the apparatuses may include or be coupled to other units or modules etc., such as radio parts or radio heads, used in or for transmission and/or reception. This is depicted in FIG. 6 as optional block 606.

Although the apparatuses have been depicted as one entity in FIG. 6, different modules and memory may be implemented in one or more physical or logical entities.

An embodiment provides an apparatus which may be any node, host, server, web stick or any other suitable apparatus capable to carry out processes described above in relation to FIG. 3.

FIG. 7 illustrates a simplified block diagram of an apparatus according to an embodiment.

As an example of an apparatus according to an embodiment, it is shown apparatus 700, such as user device or web stick, including facilities in control unit 704 (including one or more processors, for example) to carry out functions of embodiments according to FIG. 3. The facilities may be software, hardware or combinations thereof as described in further detail below.

In FIG. 7, block 706 includes parts/units/modules needed for reception and transmission, usually called a radio front end, RF-parts, radio parts, radio head, etc.

Another example of apparatus 700 may include at least one processor 704 and at least one memory 702 including a computer program code, the at least one memory and the computer program code configured to, with the at least one processor, cause the apparatus at least to: carry out configuration to operate as a local proximity services advertising agent device, the configuration comprising arranging device-to-device communication with a serving network, at least one proximity services advertising source device, and/or at least one first local proximity services advertising agent device, obtain commercial information for local delivery from the serving network, from the at least one proximity services advertising source device, and/or the at least one first local proximity services advertising agent device and deliver the commercial information to at least one receiving device and/or to at least one second local proximity services advertising agent device.

Yet another example of an apparatus comprises means 704 (706) for carrying out configuration to operate as a local proximity services advertising agent device, the configuration comprising arranging device-to-device communication with a serving network, at least one proximity services advertising source device, and/or at least one first local proximity services advertising agent device, means 704 (706) for obtaining commercial information for local delivery from the serving network, from the at least one proximity services advertising source device, and/or the at least one first local proximity services advertising agent device and means 704 (706) for delivering the commercial information to at least one receiving device and/or to at least one second local proximity services advertising agent device.

Yet another example of an apparatus comprises an operation unit configured to carry out configuration to operate as a local proximity services advertising agent device, the configuration comprising arranging device-to-device communication with a serving network, at least one proximity services advertising source device, and/or at least one first local proximity services advertising agent device, an obtaining unit configured to obtain commercial information for local delivery from the serving network, from the at least one proximity services advertising source device, and/or the at least one first local proximity services advertising agent device and a delivering unit configured to deliver the commercial information to at least one receiving device and/or to at least one second local proximity services advertising agent device.

It should be understood that the apparatuses may include or be coupled to other units or modules etc., such as radio parts or radio heads, used in or for transmission and/or reception. This is depicted in FIG. 7 as optional block 706.

Although the apparatuses have been depicted as one entity in FIG. 7, different modules and memory may be implemented in one or more physical or logical entities.

An embodiment provides an apparatus which may be any user device, web stick, or any other suitable apparatus capable to carry out processes described above in relation to FIG. 4.

FIG. 8 illustrates a simplified block diagram of an apparatus according to an embodiment.

As an example of an apparatus according to an embodiment, it is shown apparatus 800, such as user device or web stick, including facilities in control unit 804 (including one or more processors, for example) to carry out functions of embodiments according to FIG. 4. The facilities may be software, hardware or combinations thereof as described in further detail below.

In FIG. 8, block 806 includes parts/units/modules needed for reception and transmission, usually called a radio front end, RF-parts, radio parts, radio head, etc.

Another example of apparatus 800 may include at least one processor 804 and at least one memory 802 including a computer program code, the at least one memory and the computer program code configured to, with the at least one processor, cause the apparatus at least to: obtain information to operate as a local proximity services advertising agent device from a serving network, if no suitable proximity services advertising agent devices are detected, inform the serving network on suitable proximity services advertising agent devices and obtain information for being associated to at least one of the suitable proximity services advertising agent devices, if at least one suitable proximity services advertising agent device is detected, and deliver commercial information to at least one receiving device and/or to the at least one of the suitable proximity services advertising agent devices.

Yet another example of an apparatus comprises means 804 (806) for obtaining information to operate as a local proximity services advertising agent device from a serving network, if no suitable proximity services advertising agent devices are detected, means 804 (806) for informing the serving network on suitable proximity services advertising agent devices and obtain information for being associated to at least one of the suitable proximity services advertising agent devices, if at least one suitable proximity services advertising agent device is detected, and means 804 (806) for delivering commercial information to at least one receiving device and/or to the at least one of the suitable proximity services advertising agent devices.

Yet another example of an apparatus comprises an obtaining unit configured to obtain information to operate as a local proximity services advertising agent device from a serving network, if no suitable proximity services advertising agent devices are detected, an informing unit configured to inform the serving network on suitable proximity services advertising agent devices and obtain information for being associated to at least one of the suitable proximity services advertising agent devices, if at least one suitable proximity services advertising agent device is detected, and a delivering unit configured to deliver commercial information to at least one receiving device and/or to the at least one of the suitable proximity services advertising agent devices.

It should be understood that the apparatuses may include or be coupled to other units or modules etc., such as radio parts or radio heads, used in or for transmission and/or reception. This is depicted in FIG. 8 as optional block 806.

Although the apparatuses have been depicted as one entity in FIG. 8, different modules and memory may be implemented in one or more physical or logical entities.

An embodiment provides an apparatus which may be any user device, web stick, or any other suitable apparatus capable to carry out processes described above in relation to FIG. 5.

FIG. 9 illustrates a simplified block diagram of an apparatus according to an embodiment.

As an example of an apparatus according to an embodiment, it is shown apparatus 900, such as user device or web stick, including facilities in control unit 904 (including one or more processors, for example) to carry out functions of embodiments according to FIG. 5. The facilities may be software, hardware or combinations thereof as described in further detail below.

In FIG. 9, block 906 includes parts/units/modules needed for reception and transmission, usually called a radio front end, RF-parts, radio parts, radio head, etc.

Another example of apparatus 900 may include at least one processor 904 and at least one memory 902 including a computer program code, the at least one memory and the computer program code configured to, with the at least one processor, cause the apparatus at least to: obtain commercial information from a proximity services advertising source device via a local proximity services advertising agent device, and request a connection to the proximity services advertising source device via the local proximity services advertising agent device, the connection being in relation to a commercial information forwarding indicator and/or to the obtained commercial information, or request a connection to a network indicating the connection being in relation to a commercial information forwarding indicator and/or the obtained commercial information.

Yet another example of an apparatus comprises means 904 (906) for obtaining commercial information from a proximity services advertising source device via a local proximity services advertising agent device, and means 904 (906) for requesting a connection to the proximity services advertising source device via the local proximity services advertising agent device, the connection being in relation to a commercial information forwarding indicator and/or to the obtained commercial information, or requesting a connection to a network indicating the connection being in relation to a commercial information forwarding indicator and/or the obtained commercial information.

Yet another example of an apparatus comprises an obtaining unit configured to obtain commercial information from a proximity services advertising source device via a local proximity services advertising agent device, and a requestor configured to request a connection to the proximity services advertising source device via the local proximity services advertising agent device, the connection being in relation to a commercial information forwarding indicator and/or to the obtained commercial information, or to request a connection to a network indicating the connection being in relation to a commercial information forwarding indicator and/or the obtained commercial information.

It should be understood that the apparatuses may include or be coupled to other units or modules etc., such as radio parts or radio heads, used in or for transmission and/or reception. This is depicted in FIG. 9 as optional block 906.

Although the apparatuses have been depicted as one entity in FIG. 9, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be at least one software application, module, or unit configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. Computer programs may be coded by a programming language, which may be a high-level programming language, such as objective-C, C, C++, C#, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
configure an apparatus capable to device-to-device communications to operate as a local proximity services advertising agent device, and/or
configure a proximity services advertising source device to operate as a local proximity services advertising agent device or associate the proximity services advertising source device with an existing local proximity services advertising agent device, and
provide commercial information to the local proximity services advertising agent device for local delivery.

2. The apparatus of claim 1, further comprising causing the apparatus to:
obtain a service request from a user device, the service request comprising information on priority and/or commercial information factor identifying the piece of information in question, and
convey the information to at least one proximity service advertising agent device.

3. The apparatus of claim 1, wherein the apparatus or device to operate as a local proximity services advertising agent device is chosen based on at least one of the following: available capacity, power supply, a possible alternative network connection of the apparatus or device, capability information of the apparatus or device, advertising need, location information of the apparatus or device, and status information including available power and network connectivity options or conditions of the apparatus or device.

4. The apparatus of claim 1, further comprising causing the apparatus to:
configure and control both the proximity services advertising source device and the proximity services advertising agent device for possible device-to-device communications between these devices, if the proximity services advertising source device is associated with the existing local proximity services advertising agent device.

5. The apparatus of claim 1, further comprising causing the apparatus to:
provide mediating services between the proximity services advertising source device and the proximity services advertising agent device,
if a device-to-device communication fails between them.

6. The apparatus of claim 1, further comprising causing the apparatus to:
command a proximity services advertising agent device to carry out a transmission power ramp-up or down upon addition, modification or removal of an associated proximity services advertising source device or a requested proximity service.

7. The apparatus of claim 1, further comprising causing the apparatus to:
configure a direct neighbouring proximity service advertising agent device and at least one intermediate proximity service advertising agent device.

8. (canceled)

9. (canceled)

10. An apparatus comprising:
at least one processor and at least one memory including a computer program code, the at least one memory and the computer program code configured to, with the at least one processor, cause the apparatus at least to:
carry out configuration to operate as a local proximity services advertising agent device, the configuration comprising arranging device-to-device communication with a serving network, at least one proximity services advertising source device, and/or at least one first local proximity services advertising agent device,
obtain commercial information for local delivery from the serving network, from the at least one proximity services advertising source device, and/or the at least one first local proximity services advertising agent device and
deliver the commercial information to at least one receiving device and/or to at least one second local proximity services advertising agent device.

11. The apparatus of claim 10, further comprising causing the apparatus to:
set operation in a radio resource control connected state with regard to the serving network for conveying control signalling concerning at least one of the following: advertising-agent identity, capability and capacity including imposed access limitations, restrictions over at least one radio channel, updates or changes in statuses, conditions, users including associated proximity service advertising source devices.

12. The apparatus of claim 10, further comprising causing the apparatus to:
support device-to-device communications with the at least one proximity service advertising service device and/or to at least one second local proximity service advertising agent device.

13. The apparatus of claim 10, further comprising causing the apparatus to:
support device-to device communications with the at least one proximity service advertising service device and/or to at least one second local proximity service advertising agent device; and
operate as a master device or a cluster head for the at least one proximity service advertising source device

14. The apparatus of claim 10, further comprising causing the apparatus to:
carry out a transmission power ramp-up or down upon addition, modification or removal of an associated proximity services advertising source device or a requested proximity service.

15. The apparatus of claim 10, further comprising causing the apparatus to:
operate as a direct neighbouring proximity service advertising agent device or an intermediate proximity service advertising agent device.

16-30. (canceled)

31. A method comprising:
configuring an apparatus capable to device-to-device communications to operate as a local proximity services advertising agent device, and/or
configuring a proximity services advertising source device to operate as a local proximity services advertising agent device or associate the proximity services advertising source device with an existing local proximity services advertising agent device, and
providing commercial information to the local proximity services advertising agent device for local delivery.

32. The method of claim 31, further comprising:
obtaining a service request from a user device, the service request comprising information on priority and/or commercial information factor identifying the piece of information in question, and
convey the information to at least one proximity service advertising agent device.

33. The method of claim 31, wherein the apparatus or device to operate as a local proximity services advertising agent device is chosen based on at least one of the following: available capacity, power supply, a possible alternative network connection of the apparatus or device, capability information of the apparatus or device, advertising need, location information of the apparatus or device, and status information including available power and network connectivity options or conditions of the apparatus or device.

34. The method of claim 31, further comprising:
configuring and controlling both the proximity services advertising source device and the proximity services advertising agent device for possible device-to-device communications between these devices, if the proximity services advertising source device is associated with the existing local proximity services advertising agent device.

35. The method of claim 31, further comprising:
providing mediating services between the proximity services advertising source device and the proximity services advertising agent device, if a device-to-device communication fails between them.

36. The method of claim 31, further comprising:
commanding a proximity services advertising agent device to carry out a transmission power ramp-up or down upon addition, modification or removal of an associated proximity services advertising source device or a requested proximity service.

37. The method of claim 31, further comprising:
configuring a direct neighbouring proximity service advertising agent device and at least one intermediate proximity service advertising agent device.

38. (canceled)

39. A method comprising:
carrying out configuration to operate as a local proximity services advertising agent device, the configuration comprising arranging device-to-device communication with a serving network, at least one proximity services advertising source device, and/or at least one first local proximity services advertising agent device,
obtaining commercial information for local delivery from the serving network, from the at least one proximity services advertising source device, and/or the at least one first local proximity services advertising agent device and
delivering the commercial information to at least one receiving device and/or to at least one second local proximity services advertising agent device.

40. The method of claim 39, further comprising:
setting operation in a radio resource control connected state with regard to the serving network for conveying control signalling concerning at least one of the following: advertising-agent identity, capability and capacity including imposed access limitations, restrictions over at least one radio channel, updates or changes in statuses, conditions, users including associated proximity service advertising source devices.

41. The method of claim 39, further comprising:
supporting device-to-device communications with the at least one proximity service advertising service device and/or to at least one second local proximity service advertising agent device.

42. The method of claim 39, further comprising:
supporting device-to-device communications with the at least one proximity service advertising service device and/or to at least one second local proximity service advertising agent device; and
operating as a master device or a cluster head for the at least one proximity service advertising source device.

43. The method of claim 39, further comprising:
carrying out a transmission power ramp-up or down upon addition, modification or removal of an associated proximity services advertising source device or a requested proximity service.

44. The method of claim 39, further comprising:
operating as a direct neighbouring proximity service advertising agent device or an intermediate proximity service advertising agent device.

45-58. (canceled)
